(19) United States
(12) Patent Application Publication
(10) Pub. No.: US 2026/0119143 A1
(43) Pub. Date: Apr. 30, 2026

(54) LOOP POINTERS WITHIN CONDITIONAL CONSTRUCT

(71) Applicant: Zoho Corporation Private Limited, Kanchipuram District (IN)

(72) Inventors: Sridhar Vembu, Tenkasi (IN); Akshhayaa S, Guduvanchery (IN); Joseph Sathya Kumar, Chennai (IN); Subathra Periakaruppan, Madurai (IN); Shalini Lakshmi A J, Chennai (IN); Punithavathi Palani, Chennai (IN); Sudheer Grandhi, Pleasanton, CA (US)

(73) Assignee: Zoho Corporation Private Limited, Kanchipuram District (IN)

(21) Appl. No.: 19/368,256

(22) Filed: Oct. 24, 2025

Related U.S. Application Data
(60) Provisional application No. 63/728,346, filed on Dec. 5, 2024.
(60) Provisional application No. 63/728,836, filed on Dec. 6, 2024.

(30) Foreign Application Priority Data
Oct. 24, 2024 (IN) 202441081185
Oct. 25, 2024 (IN) 202441081556

(51) Int. Cl. G06F 8/41

(52) U.S. Cl. CPC G06F 8/452

(57) ABSTRACT

A Loop Pointer (LP) construct is disclosed for identifying terms in a recursive expression operated within a branching construct, having a condition, within an iterator construct. A Loop Pointer Variable (LPV) is assigned the current value of the recursive expression comprising one or more previous values or prior terms of the LPV. The prior terms or values are identified in source code by a loop pointer construct modifying a reference to the loop pointer variable. A compiler generates instructions to access each of the one or more identified variable values for use in computation of the current value when the condition of the branching construct is met at runtime. An access to the iterator construct output can request the terminal value of the loop pointer value, a sequence of one or more of a series comprising updates to the value when the condition is met, or a series of the values in each iteration.

### CROSS REFERENCE TO RELATED APPLICATIONS

This application is related to Indian Provisional Application 20/244,1081185 filed 24 Oct. 2024, and U.S. Provisional Application 63/728,346, filed 5 Dec. 2024, both entitled “LOOP POINTERS”, both incorporated herein by reference. This application is also related to Indian Provisional Application 20/244,1081556, filed 25 Oct. 2024, entitled “LOOP POINTER CONSTRUCT”, and U.S. Provisional Application 63/728,836, filed 6 Dec. 2024, entitled “LOOP POINTERS CONSTRUCT”, both incorporated herein by reference. This application is also related to co-pending U.S. application Ser. No. 19/367,132, filed 23 Oct. 2025, entitled “LOOP POINTERS”, and co-pending U.S. application Ser. No. 19/367,237, filed 23 Oct. 2025, entitled “LOOP POINTERS FOR RECURSIVE TO ITERATIVE TRANSFORMATION”, both incorporated herein by reference.

### FIELD OF THE INVENTION

Embodiments of the present disclosure are related, in general, to computer programming languages and more particularly, but not exclusively, to automated compiler-generated support for recursive statements.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1A depicts an example embodiment of a computational device 100 which comprises a compiler 130 operable with an Intermediate Representation (IR) 140 of source code 110 to perform loop pointer processing.

FIG. 1B illustrates executable code 160 loaded into a memory 150 of computational device 100 to perform loop pointer management at runtime.

FIG. 2 is a flowchart 200 illustrating an example embodiment of compiler-generated loop pointer instructions.

FIG. 3 is a flowchart 300 illustrating an example embodiment of loop pointer initialization validation.

FIGS. 4A and 4B depict flowchart 400 illustrating another example embodiment of compiler-generated loop pointer instructions.

FIG. 5 is a flowchart 500 illustrating a variety of example accesses to loop pointer variables found in source code and compiler-generated instructions prepared in response.

FIG. 6A illustrates loop pointers in a recursive expression enclosed within a branching construct.

FIG. 6B illustrates an iterator construct having multiple branching constructs and multiple loop pointer variables.

FIG. 7 is an alternate flowchart 500 illustrating example accesses to an iterator with conditional loop pointer variable updating.

FIGS. 8A and 8B introduce auto-initialization as a modification to FIG. 3.

FIG. 9 is an example compiler 130 illustrating Loop Pointer Manager 940 operating on an intermediate representation.

FIG. 10 illustrates an example embodiment of distributed IDE 1000 including components of a computational device, or user terminal, 100.

### DETAILED DESCRIPTION

A Loop Pointer (LP) construct is disclosed for identifying terms in a recursive expression operated with an iterator. A Loop Pointer Variable (LPV) is assigned the current value of the recursive expression comprising one or more previous values or prior terms of the LPV. The prior terms or values are identified in source code by a loop pointer construct modifying a reference to the loop pointer variable. In one embodiment, a compiler, responsive to encountering a loop pointer construct, generates instructions to access each of the one or more identified variable values for use in computation of the current value of the loop pointer variable at runtime.

An access to the iterator construct output can request the terminal value of the loop pointer variable. An access to the iterator construct output can request a sequence of one or more loop pointer variable values in the series of updated loop pointer variables. In one embodiment, a loop pointer variable is updated once during each iteration. When an access requests a sequence of variable values, the compiler generates instructions to allocate storage for storing the sequence, for storing the loop pointer variable values as updated in the allocated storage, and for returning the sequence upon termination of the iterator.

In an alternate embodiment, the compiler transforms the recursive expression into an equivalent iterative computation and generates instructions to compute the current value at runtime. The iterator enables sequential traversal through a data structure, such as an array, list, tree, and others, without exposing the internal implementation of the data structure. For illustration, a sequential iterator has been shown in the following examples. In general, an iterator can iterate over any data structure like a sequence, matrix, tree, graph, and so forth.

In another embodiment, the iterator construct includes the recursive expression in a statement enclosed within a branching construct having a condition. The statement defines computation of a current value of a variable based on one or more previous values of the loop pointer variable, each identified by a loop pointer construct. The compiler generates instructions to access each of the one or more identified previous loop pointer variable values for use in computation of the current value when the condition of the branching construct is met at runtime. An iterator construct may enclose multiple branching constructs, as well as branches, having various conditions. An iterator may enclose multiple loop pointer variables.

An access to the conditional-branch iterator may, as in other embodiments, return the terminal value of the loop pointer variable. In embodiments in which a loop pointer is conditionally updated, updates to a loop pointer variable may occur less often than once per iteration. As such, two sequence access types are disclosed, referred to as an iteration sequence and an update sequence. The iteration sequence, like in non-conditional iteration, returns a sequence of one or more values of the loop pointer variable for a corresponding sequence of iterations. However, this requires maintaining LPV values in iterations in which the LPV is not updated. Responsive to encountering an iteration access in the source code, the compiler generates instructions to allocate storage for storing the iteration sequence which includes storing the updated value of the variable during an iteration when the condition is met and storing the value of the previous iteration during an iteration when the condition is not met, and for returning the iteration sequence upon termination of the iterator. The update sequence will comprise a sequence of loop pointer variables as updated, which may be fewer than the number of iterations. Responsive to encountering an update sequence access, the compiler generates instructions to allocate storage for storing the update sequence which includes storing the updated value of the variable to the sequence only during an iteration when the condition is met. The compiler generates the appropriate instructions responsive to the various access types encountered in the source code.

In various embodiments, using any of a variety of syntaxes, techniques and constructs in source code, initial values are supplied for use in one or more initial iterations. The compiler determines whether the appropriate set of initial values are supplied via source code. When they are, the compiler generates instructions for utilizing the initial values in the one or more initial iterations for which they are required. The compiler generates a message indicating a missing initial value otherwise. In other embodiments, the compiler may auto-initialize initial values. For example, the additive or multiplicative identities may be used for addition/subtraction or multiplication/division, respectively. Other special-purpose initialization strategies may be incorporated in the compiler for other types of recursions. Or the compiler may prompt the user to supply a missing value.

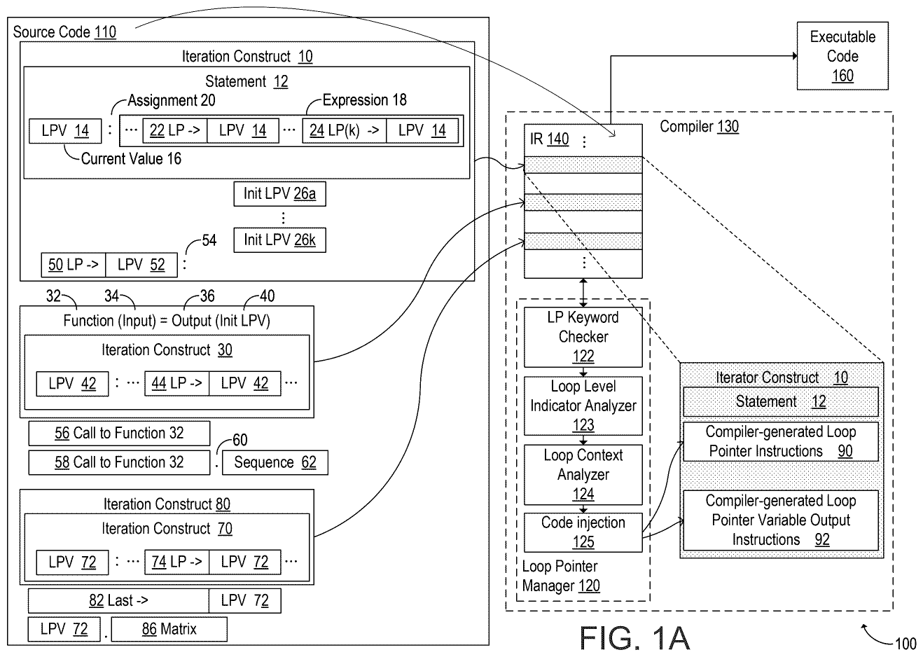

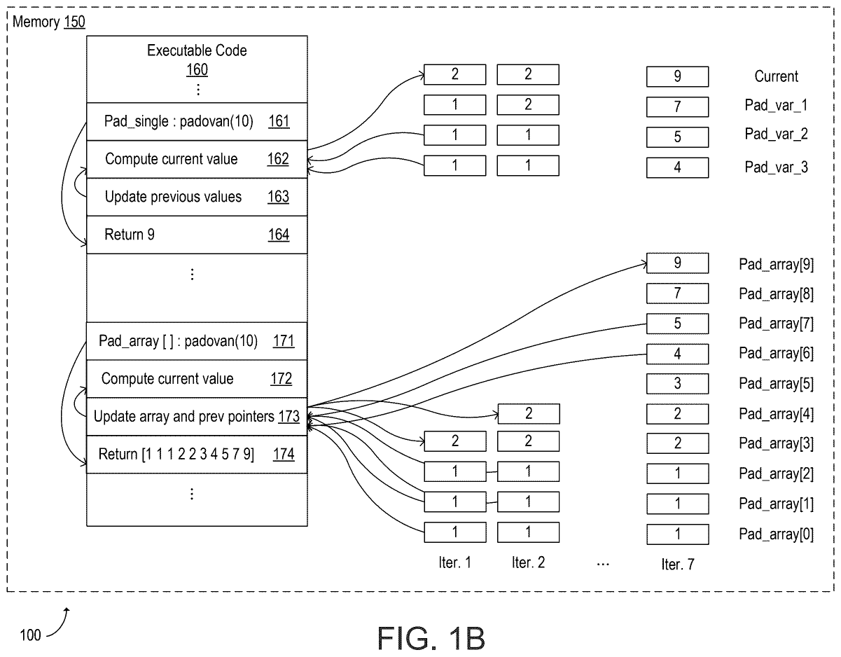

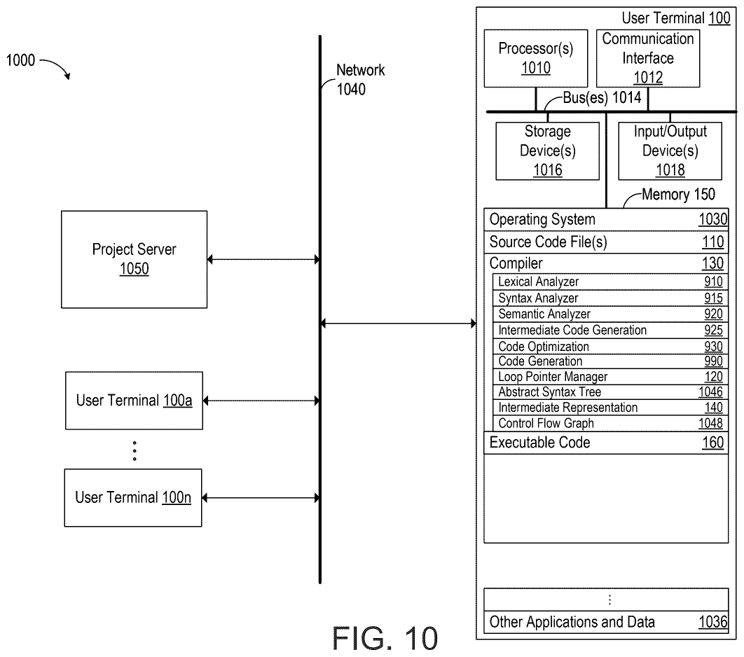

FIG. 1A depicts an example embodiment of a computational device 100, such as a computer or user terminal, detailed further below with respect to FIG. 10, which comprises a compiler 130 operable with an Intermediate Representation (IR) 140 of source code 110 to perform loop pointer processing. IR 140 can be further compiled to produce executable code 160. FIG. 1B illustrates executable code 160 loaded into a memory 150 of computational device 100 to perform loop pointer management at runtime.

Compiler 130 generates intermediate representation (IR) 140 from source code 110. Loop pointer manager (LPM) 120 operates on IR 140, which can be any type of IR, and can operate on source code directly in an alternate embodiment. LPM 120 auto-generates instructions for loop pointer support at runtime. A variety of embodiments are disclosed for auto-generating these instructions during compile time. In all of those, however, with the resultant executable code, at runtime, loop pointers in recursive statements are maintained automatically and accurately without requiring intervention in source code by a programmer. Any number of additional compiling phases may be performed on IR 140, and IR 140 may be compiled into executable code 160.

Source code 110 comprises symbolic representations of example constructs to illustrate several loop pointer aspects. Iterator construct 10 includes recursive statement 12 in which a current value 16 of expression 18 is computed and assigned by assignment operator 20 to a loop pointer variable LPV 14. The expression 18 is recursive in that it includes at least one reference to a previous value of LPV 14. Any number of additional operators and constructs may be included in the statement as well. Here, loop pointer LP 22 modifies LPV 14 and loop pointer LP(k) 24 modifies LPV 14. Each LP identifies a different previous value of the LPV, and those values are used in computing expression 18. A set of initial values for LP (k) 24 are supplied as Init LPVs 26a-k.

Two example types of loop pointer syntax are shown in Examples 1 and 2.

$$1 loop\_pointer -> loop\_pointer \_variable$$

### Example 1. Loop Pointer Syntax-Directly Previous-Loop Level 1

In Example 1, a loop pointer construct, loop_pointer->, modifies the loop pointer variable, loop_pointer_variable. This construct, without further modification, indicates the value of the loop pointer variable directly preceding the update of the current value is to be accessed by the loop pointer construct. An example is prev->partial_sum. Here, the construct prev-> is selected to indicate a loop pointer construct (also referred to generally as a pointer construct) modifying the loop pointer variable, partial_sum. To access the former value of partial_sum in computing an update to partial sum, the syntax is prev->partial_sum.

$$1 loop\_pointer ( x ) -> loop\_pointer \_variable$$

### Example 2. Loop Pointer Syntax-Loop Level>1

Example 2 illustrates the syntax for use when a value of loop_pointer_variable other than the directly previous value is required: loop_pointer (x). By convention here, x, the loop level indicator, indicates the distance a prior value or prior term, identified by a loop pointer, is from the current value or current term. An example, prev(2)->fib, indicates a value of LPV fib that is 2 values or terms prior, as the loop level indicator is 2.

Both syntactically distinct loop pointers, loop_pointer-> and loop_pointer(x)->, indicate the loop level. If there is no explicit loop level indicator value, or (x) is not specified, as in line 1 of Example 1, the loop level indicator is 1, e.g. prev(1)-> is represented as prev-> by default.

In an embodiment in which an iterator updates the loop pointer variable during every iteration, referencing a previous value with a loop level indicator is equivalent to identifying a previous term in a series or indicating the distance a previous value is from the current term. Often the distance may indicate time, but it can be applied to any positional relativity of terms in a series. In various examples used throughout, loop level indicator is used synonymously with iteration level, unless otherwise specified. In an alternate definition, each preceding value to a current value of an LPV is said to lag that current value. Each preceding value lags the current value by a lag value, which is the number of prior updates to the LPV at which the referenced preceding value was computed. There can be one or more pointer constructs deployed in an expression, each with a different lag value. The maximum lag value among the one or more pointer constructs is referred to as the lag depth for the statement. In general, a pointer construct refers to a previous value of the LPV, except in the first one or more iterations. In the first iteration, pointer constructs identify initialization values. One or more pointer constructs in the expression will refer to an initialization value until the number of updates exceeds the lag depth.

Again, in illustrations throughout, the number of updates will often be synonymous with number of iterations, but this is not a requirement. For example, as illustrated below, when a conditional branch is included in the iterator enclosing a recursive expression assigned to an LPV, that LPV may update less frequently than each iteration. In this case, pointer constructs indicate the lag in number of updates, not iterations. As such, the reference to a previous LPV value by loop level is still apt. However, in that instance, loop level is no longer equivalent to iteration count. Alternate syntax can be substituted for any of the indicators and operands.

Source code 110, in FIG. 1A, includes an illustrative function 32, having an input 34, and supplying an output 36. In this example, an initial value 40 for a loop pointer is also defined to supply requisite initialization through a function call. Alternate syntax may be deployed. For example, having an input is optional. The output parameter may be replaced by a return operator within a function. The initialization parameters may also be established elsewhere, as shown in the snippet of Example 3, below. Additional features include passing a single value initialization, or a sequence. Output of the last term of the recursive iteration may be the default. The output may be changed based on the function call, where, for example, a defined sequence, an array, a matrix, or other structure may be returned responsive to the type to which the output is assigned. A variety of examples, not exhaustive, are provided below. Any number of syntax embodiments for passing parameters or returning values will be readily deployed by those of skill in the art. Function 32 includes iterator construct 30 operating over the loop pointer variable LPV 42 computed as a function of at least one previous value identified by LP 44 (modifying LPV 42 on the right-hand side).

Consider the code snippet of Example 3 which illustrates a function to sum up an array of numbers.

| | |
|---|---|
| 1 | sum(input[ ] :: number[ ]) = last->partial_sum |
| 2 | /input# |
| 3 | partial_sum : prev->partial_sum + input |
| 4 | init->partial_sum : 0 |

### Example 3. Loop Pointer Used to Sum an Array

Function “sum” (line 1) is a function whose input parameter is “input[ ]”, which is typed (::) as an array of numbers. The output of sum is last->partial_sum. The construct “last->” is defined to modify the LPV partial_sum and provides the value of partial_sum after the last iteration. In line 2, /input# is a sequential iterator, equivalent to a for loop. The compiler determines that there is an array “input[ ]” and every element of the array is identified as “input”. The symbol ‘/’ denotes an iterator or beginning of the loop. The symbol ‘#’ denotes that every element in the input sequence is iterated. Line 4 includes a statement in which an initialization construct “init->” modifying the LPV partial_sum assigns prev->partial_sum to 0. The value of prev->partial_sum is initialized to 0 for use in the first iteration, for which no previous iteration value exists. This is an example of a syntax option for initialization different than Init LPV 40 in FIG. 1A.

TABLE 1
Sample Execution of Example 3

| Iteration | Input | partial_sum | prev->partial_sum |
|---|---|---|---|
| 1 | 5 | 5 = 5 + 0 | 0 |
| 2 | 6 | 11 = 6 + 5 | 5 |
| 3 | 3 | 14 = 3 + 11 | 11 |
| 4 | 4 | 18 = 4 + 14 | 14 |

The flow of execution of Example 3 is illustrated in Table 1. Consider an input array [5, 6, 3, 4]. Since the total number of elements in the input array is 4, the number of iterations is also 4. The iterator iterates the array starting from the first element, 5, one element per iteration, until the last element, 4, is reached. As described above, the value of prev->partial_sum is initialized to 0 for the first iteration. During every iteration, the value of partial_sum is assigned the statement value computed by adding the input instance supplied by the iterator to the previous value of partial_sum passed to the current iteration through the loop pointer, prev->partial_sum. The value of prev->partial_sum is updated with the value of the LPV, partial_sum, at the end of each iteration. The process continues through the last iteration. After the last iteration, the value of “partial_sum” is returned as output, which, in this illustration, is 18.

Note that the value of the loop pointer variable prev->partial_sum is unmodifiable in the source code by the user. Attempting to assign a value to a loop pointer will generate an error. For example, in FIG. 1A, loop pointer 50 is modifying loop pointer variable 52. When the compiler encounters an attempted assignment via operator 54, it will not allow it.

Consider another example function, factorial, illustrated in the code snippet of Example 4.

| | |
|---|---|
| 1 | factorial(input :: number) = last->partial |
| 2 | [1..input]/element# |
| 3 | partial : prev->partial * element |
| 4 | init->partial : 1 |

### Example 4. Factorial Function

Example 4 illustrates function ‘factorial’ whose input parameter, ‘input’, is a number. It evaluates to last->partial which is the value of partial after the last iteration (line 1). In line 2, ‘[1 . . . input]/element#’ is a sequential iterator operating on a sequence of values from 1 to the value of ‘input’ (e.g., if input=5, then [1 . . . input] is a sequence [1, 2, 3, 4, 5]). The variable ‘element’ iterates over each value in [1 . . . input], i.e. ‘element’ is the value of an element in [1 . . . input] in an iteration (if input=5, then ‘element’ is 3 in Iteration 3). Line 3 includes a recursive expression. The LHS ‘partial’ is a LPV which is private to the scope of the enclosing construct and cannot be referred to outside. In other words, it is thought of as “private partial” and it is private to the enclosing construct. When the compiler encounters a partial used by the programmer outside of this scope, then a compile-time error is generated. Line 4 includes an “init->” statement. During the very first iteration, there is no previous partial, hence the value of prev->partial is initialized to 1.

Consider another example function, fibonacci, illustrated in the code snippet of Example 5.

| | |
|---|---|
| 1 | fibonacci(n :: number) = last->fib |
| 2 | [3..n]/# |
| 3 | fib : prev->fib + prev(2)->fib |
| 4 | init->fib : 1 |
| 5 | init(2)->fib : 0 |
| 6 | |
| 7 | fibonacci(n :: number) = number[ ](init : [0, 1]) |
| 8 | [3..n]/# |
| 9 | fib : prev->fib + prev(2)->fib |

### Example 5. Fibonacci Function with Prev(x)

In Example 5, “fibonacci” is a function whose parameter “n” is a number. It evaluates to last->fib (fib after the last iteration) (line 1). Lines 2-5 constitute an iterator construct. In line 2, ‘[3 . . . n]/#’ is a sequential iterator. Line 3 includes a recursive expression comprising prev(k) in the RHS, prev->fib and prev(2)->fib. From the RHS part of the recursive expression in line 3, the maximum value of the loop level indicator is 2. Hence, the developer provides two ‘init’ statements. Lines 4-5 include “init->” statements.

Lines 7-9 illustrate the same function with another syntax for initial values. Here, init values are defined using a sequence, and attached in the header of the function call, as shown. This is convenient when, as shown, a recursive expression has multiple init statements. Note that, in embodiments detailed herein, initial values have been illustrated using constant values. In various embodiments, initial values may be constant or variable, passed through arguments to a function and assigned within the function, or passed as parameters for initialization as shown. Various other options and syntaxes will be apparent to those of skill in the art. In each case, the compiler ensures that the right number of appropriate initialization values are supplied, whether fixed or variable, during compilation.

TABLE 2
Sample Execution of Fibonacci Example 5

| | Loop | | | |
|---|---|---|---|---|
| Iteration | Counter | fib | prev->fib | Prev(2)->fib |
| 1 | 3 | 1 = 1 + 0 | 1 | 0 |
| 2 | 4 | 2 = 1 + 1 | 1 | 1 |
| 3 | 5 | 3 = 2 + 1 | 2 | 1 |
| 4 | 6 | 5 = 3 + 2 | 3 | 2 |

Table 2 illustrates the flow of execution of the Fibonacci program in Example 5, for an input n=6. When the input n=6, the loop counter will take on the values 3, 4, 5 and 6 during iteration. The first two fibonacci numbers (0 and 1) are known from the init statements. These values are assigned to prev->fib and prev(2)->fib, respectively, before the loop begins, as shown in lines 2 and 3 (or 8 and 9), so there's no need to compute them. Hence, the iteration starts from 3 and goes to 6, producing the current values (fib) as shown.

In an example embodiment, n can be less than 3. For example, if n=1, then a descending sequence [3 . . . 1] is formed through which the compiler identifies that there is no need to begin an iteration. Instead, the init->fib(2):0, is returned as output.

In FIG. 1A, LPM 120 includes the following components: LP Keyword Checker 122, Loop Level Indicator Analyzer 123, Loop Context Analyzer (LCA) 124, and Code injection module 125. These components provide a variety of functions related to loop pointer management. LP Keyword Checker 122 locates keywords such as pointer constructs such as loop pointers, associated loop pointer variables, and surrounding statements, iterator constructs and/or functions.

Loop Level Indicator Analyzer 123 extracts the loop level indicator value, or lag, from each LP and determines the maximum value of the loop level indicator, or lag depth. The maximum value of the loop level indicator is provided to the LCA 124.

Loop Context Analyzer 124 analyzes the IR to evaluate each loop pointer construct and its use in statements, iterator constructs, and functions. Error checking is performed to ensure correct use of constructs. For example, initialization requirements are validated, illustrated further below. Scope limitations are checked. User-modification of loop pointers is prevented. Various features, e.g. type of output produced from an iterator construct iterating on a recursive statement identified by loop pointers, are implemented based on the context of the iterator constructs as well as calls to or use of those constructs.

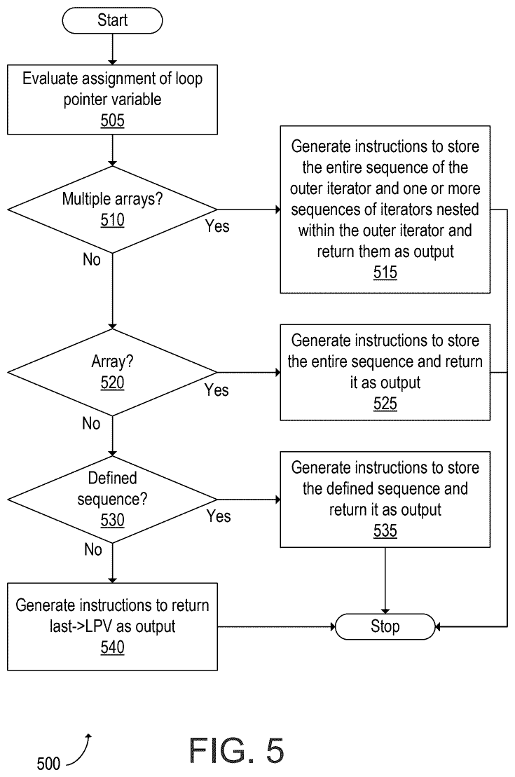

LPM 120 generates code to facilitate loop pointers. Code injection module 125 then injects the generated code. In the example embodiment, the analysis and code injection occurs at the IR level. Alternate embodiments may operate on source code, machine code, or any level in between. For illustration, iterator construct 10 and statement 12 are shown as part of IR 140. Compiler-generated loop pointer instructions 90 are injected into IR 140 to access loop pointers for use in computing statement 12. Various output options for a loop pointer variable, examples are illustrated below with respect to FIG. 5. Corresponding compiler-generated loop pointer variable output instructions 92 are injected into IR 140 for supported options.

In certain cases, a function can return a value even when the iterator does not need to be executed. In an example embodiment, the LPM includes a Null Input Handler. The null input handler injects code to handle null input cases during run time. Null input cases are obtained when the input passed is empty. The compiler returns the init value through last->LPV during runtime if the input is null. In another example, as described above, when a request for a series value that is in the initialization values, the respective value can be returned without computation of the expression. A combination of init values and iteration outputs may be returned when a sequence output is requested, and the request overlaps the init values and those requiring computation.

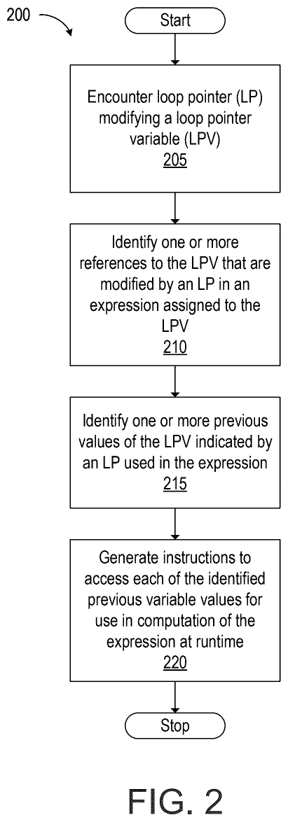

FIG. 2 is a flowchart 200 illustrating an example embodiment of compiler-generated loop pointer instructions. The compiler encounters a loop pointer (LP) modifying a loop pointer variable (LPV) (205). The compiler identifies this reference along with any other references to the LPV, modified by an LP, in an expression assigned to the LPV (210). Each LP identifies a previous value of the LPV, so one or more previous LPV values are identified (215). The compiler then generates instructions to access each of the identified previous values for use in computation of the expression at runtime (220).

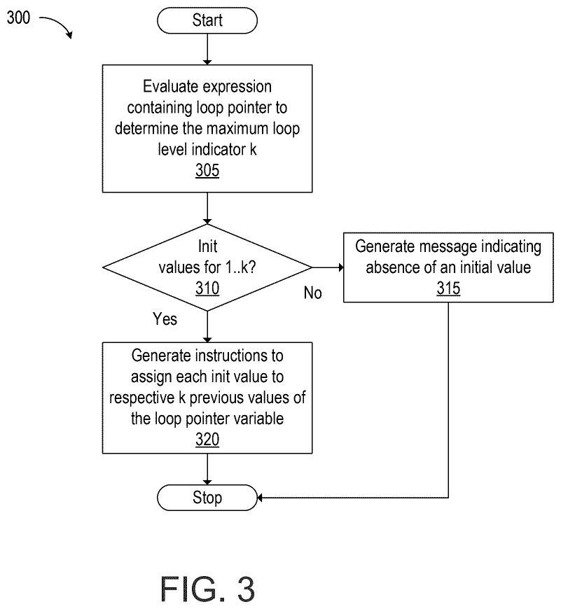

FIG. 3 is a flowchart 300 illustrating an example embodiment of loop pointer initialization validation. An expression containing one or more loop pointers is evaluated to determine the maximum loop level indicator, k (305). The source code (in IR format in the example embodiment) is evaluated to determine whether the proper number initial values has been supplied (310). For loop level indicator k, there should be k initialization values. If there are not sufficient initializations provided, then an error and/or message is generated indicating absence of an initial value (315). When valid initialization is supplied, the compiler generates instructions to assign each initial value to respective k previous values of the loop pointer variable which will be accessible via loop pointers in the evaluation of the recursive expression.

Consider another example function, padovan, illustrated in the code snippet of Example 6.

| | |
|---|---|
| 1 | padovan(n::number) = last->pad |
| 2 | [4..n]/# |
| 3 | pad : prev(2)->pad + prev(3)->pad |
| 4 | init(2)-> pad :1 |
| 5 | init(3)-> pad :1 |
| 6 | |
| 7 | padovan(n :: number) = last->pad |
| 8 | [4..n]/# |
| 9 | pad : prev(2)->pad + prev(3)->pad |
| 10 | init->pad : 1 |
| 11 | init(2)-> pad : 1 |
| 12 | init(3)-> pad : 1 |

### Example 6. Padovan Function with Init. Error Illustration

Function padovan has input parameter number n. It evaluates to last->pad (line 1). Lines 2-5 constitute an iterator iterating a recursive expression. In line 2, [4 . . . n]/# is a sequential iterator. Line 3 includes the recursive expression with prev(2)->pad and prev(3)->pad. The loop pointer, prev->pad, is not used in the recursive expression. In this illustration, the developer has included init statements on lines 4 and 5 for the pointers used in the recursive expression. When the compiler evaluates this code, e.g. flowchart 300, it determines that k=3, and, finding only two init values, generates an error. The developer is prompted to provide the missing init->pad: statement. The correct code, with all three initializations is shown in lines 7-12. Note that in all the prior examples, the compiler will have made the same initialization validation. The examples above all have the correct initialization.

TABLE 3
Sample Execution of Padovan Example 6

| | Loop | | | | |
|---|---|---|---|---|---|
| Iteration | Counter | pad | prev->pad | prev(2)->pad | prev(3)->pad |
| 1 | 4 | 2 = 1 + 1 | 1 | 1 | 1 |
| 2 | 5 | 2 = 1 + 1 | 2 | 1 | 1 |
| 3 | 6 | 3 = 2 + 1 | 2 | 2 | 1 |
| 4 | 7 | 4 = 2 + 2 | 3 | 2 | 2 |
| 5 | 8 | 5 = 3 + 2 | 4 | 3 | 2 |

The flow of execution of Example 6 is illustrated in Table 3. The three initialization values are stored via loop pointers as shown. While prev->pad is not used in the expression, it is used to store the current value after an iteration and deliver the prior version to prev(2)->pad. The computations are as shown, with the result of 5 being output.

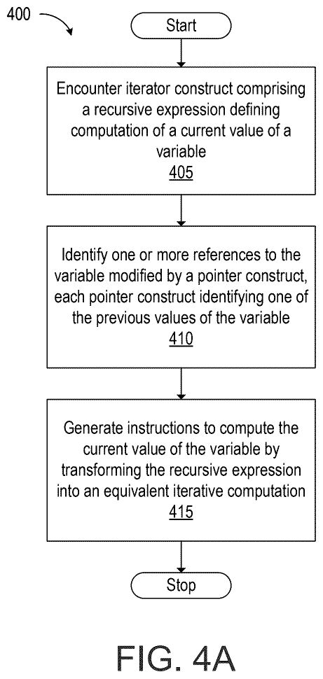

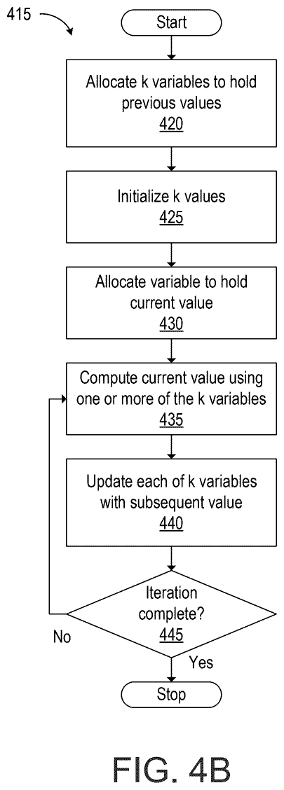

FIGS. 4A and 4B depict flowchart 400 illustrating another example embodiment of compiler-generated loop pointer instructions. In FIG. 4A, the compiler encounters an iterator construct comprising a recursive expression defining computation of a current value of a variable (405). The compiler identifies one or more references to the variable modified by a pointer construct, each pointer construct identifying one of the previous values of the variable (410). The compiler generates instructions to compute the current term by transforming the recursive expression into an equivalent iterative computation (415).

In FIG. 4B, an example set of instructions to be produced in step 415 and to be executed at runtime is illustrated. Instructions allocate k variables to hold previous values (420). The k values are initialized (425). A variable is allocated to hold the current value (430). The current value is computed using one or more of the k variables (435). Each of the k variables is updated with a subsequent variable (440). If the iteration is complete (445), the process stops. If not, repeat the compute and update steps until the iteration is complete.

An example output of flowchart 400, compiler-generated loop pointer instructions for padovan, is illustrated in the code snippet of Example 7.

| | |
|---|---|
| 1 | padovan(n :: number) = pad |
| 2 | prev_pad_1 := number(init : 1) |
| 3 | prev_pad_2 := number(init : 1) |
| 4 | prev_pad_3 := number(init : 1) |
| 5 | [4..n]/i# |
| 6 | pad : prev_pad_2 + prev_pad_3 |
| 7 | prev_pad_3 : prev_pad_2 |
| 8 | prev_pad_2 : prev_pad_1 |
| 9 | prev_pad_1 : pad |

### Example 7. Pseudocode of Compiler-Generated Instructions for Padovan

Here the function has the same input and output as the user-supplied function illustrated in Example 6 (line 1). The iterator (line 5) is also the same. Here, the recursive expression has been transformed to an iterative expression. Three variables, prev_pad_1, prev_pad_2, and prev_pad_3 are allocated and initialized (lines 2-4). Then, pad (LPV) is computed as prev_pad_2 (prev(2)->pad)+prev_pad_3 (prev(3)->pad) (line 6). The prior values (loop pointers) are updated as shown in lines 7-9. The process repeats until the iterator completes. The same process may be applied to the other Examples illustrated herein (details not shown).

In FIG. 1A, a call 56 to Function 32 is made. This will result in the function returning the output 36 as defined. However, if a call 58 to Function 32 can be made with a modifier to indicate that the sequence (or part thereof) is to be returned. In this example, an operator 60, “.”, followed by a sequence variable indicates to the compiler that in addition to the iterator and loop pointer management required, instructions to allocate storage for, to maintain, and to return the sequence will be generated. Alternate syntax may be deployed in alternate embodiments. This is an example of compiler-generated loop pointer variable output instructions 92. Additional examples are detailed further below.

FIG. 1B illustrates runtime operation of compiler-generated loop pointer instructions. Here, two demonstrations using the Padovan example are illustrated, one for the default last->pad return, and one for a sequence return. IR 140 has been compiled into executable code 160 and loaded into a memory 150 for runtime execution. Example instructions are included to illustrate. Compile and runtime environment 100 may be implemented on a computer such as a user terminal detailed below in FIG. 10. Shown together here for convenience only, it is not necessary to have the runtime environment and compile environment on the same device. Compiled executable programs can be distributed for executing in any number of implemented runtime environments. At runtime, memory 150 is loaded with executable programs, such as program executable 160. Other programs such as a memory management system and other operating system functions are not shown.

The layout of memory 150 is illustrative only. Executable code can be loaded in any portion of memory, contiguously or otherwise, in similar order to the stored executable, or rearranged, or in any other configuration. The same is true for objects and other runtime data. It is common practice for instructions to be stored in a stack, and object data to be stored in a heap, but any memory management technique may be employed.

The first demonstration is a call 161 to function padovan with input 10, allocated to Pad_single, which is a number. The second call 171 is the same except that the result is assigned to Pad_array[ ], which is a sequence. Both are consistent with output of a process such as flowchart 400 but illustrate different approaches as well as different function output types.

In the first demonstration, four registers or variables are allocated, one for the current value and three for the previous values. The lower three, Pad_var_1, Pad_var_2, and Pad_var_3 include the initialization values, which are all set to 1 in the Padovan sequence, and represent prior values as labeled. As shown, the instruction 162 to compute the current value uses prev(2)->pad, Pad_var_2, and prev(3)->pad, Pad_var_3. Padovan(10) requires 7 iterations, a subset of which are illustrated as shown. In the first iteration, the current value is computed and stored. Then, the previous values are updated 163. Thus, the top three values are shifted into the bottom three as shown, and the next current value is stored. The process continues until the registers in the 7^{th} iteration comprise the values 9, 7, 5, and 4. Last->pad is the current value, so 9 is returned (164).

In the second demonstration, Pad_array[9:0] is allocated to store the sequence for output and to provide loop pointer values for the computation. In addition, the initial values are stored in Pad_array[2:0]. The loop pointers in this example are literal pointers into the array, which will be incremented each iteration. Only initialized and stored values in the array are shown in the figure for clarity. The first iteration has the same initialization in the bottom three array positions as above. The computation 172 is naturally the same. However, as shown, the current value gets written in a higher position in the array each iteration. The previous values are unchanged, only the pointers are updated 173. Finally, the complete sequence [1 1 1 2 2 3 4 5 7 9] is available after the 7^{th} iteration and is returned.

In this example, the entire Padovan sequence is returned, which includes the initial values, as they form part of the sequence. In alternate examples, that may not be the desired result. For example, returning the initial value of 0 for a series of sums may not be desired. Whether or not to include initial value or values in a return sequence is a design choice that can vary in alternate embodiments.

Note the storage allocation may comprise registers, variables, arrays, matrices, or other structures. Implementation details of how to update loop pointers will vary by embodiment, and various techniques are well known in the art. For example, in one embodiment each of a set of registers receives the output of another and is updated sequentially, requiring 4 register updates per iteration (using the first demonstration as an example). Alternately, 4 registers may be deployed, with pointers used to indicate which is the current value and which are the specific previous values. In this case, a single update (the current value) is used, with pointer increments, for example. The use of the array in demonstration 2 is another alternate technique for maintaining loop pointers. This example has illustrated various features of transforming the recursive expression into an equivalent iterative computation.

In general, the compiler generated instructions will include allocating a first storage location to store the current value, and responsive to computing the current value at runtime, storing the current value in the first storage location as a first preceding value for a subsequent computation.

Each preceding value identified in the recursive expression is referenced by respective lag in its associated pointer construct. Upon evaluating the lag values indicated by each pointer construct, a lag depth is determined as the maximum lag value among them. When lag depth is one, the first storage location is sufficient. Responsive to the lag depth exceeding one, one or more additional storage locations sufficient to maintain preceding values up to the lag depth minus one are allocated. When the current value is computed at runtime, the instructions are generated to store the current value as a new preceding value and maintain the required preceding values in the allocated storage locations to preserve their accessibility for subsequent computations according to their respective lag values. As detailed above, those of skill in the art will recognize myriad approaches to storing the new preceding value and maintaining the other required preceding values for use in the next computation.

The lag depth is also used to determine whether a suitable set of initial values is defined in source code. The set includes a number of initial values equal to the lag depth, and covers each initial values associated with a lag between one and the lag depth. When the suitable set is defined, the compiler generates instructions to supply the initial values for use in computing one or more initial current values during one or more initial iterations at runtime. Otherwise, a compiler message to indicate the absence of an initial value may be generated.

The loop pointer construct can be defined in a nested structure, where the recursive expression is built in the inner loop nested within an outer loop. Referring to FIG. 1A, iteration construct 80 has iteration construct 70 nested within. The loop pointer variable, LPV 72 is assigned a recursive expression including at least one previous value, loop pointer 74 modifying LPV 72.

An example nested loop pointer structure is illustrated in Example 8.

| | |
|---|---|
| 1 | matrix_accumulator(input[ ][ ] :: number[ ][ ]) = last->accum |
| 2 | input[ ][ ]/inner[ ]# --outer loop (for row) |
| 3 | inner[ ]/val# --inner loop (for column) |
| 4 | accum : prev->accum + val |
| 5 | init->accum : 0 |

### Example 8. Matrix Accumulator Illustrating Nested Loop Pointer Construct

Example 8 is a program to add the values of all the elements of an input matrix and return the final sum of all the elements. The computation of the sum of elements in each row is performed first. The row-sums are used for the calculation of a cumulative total. In line 1, the function parameter is a matrix or a two-dimensional sequence. The function “matrix_accumulator” evaluates to “last->accum. The outer loop begins in line 2, with an iterator “input[ ][ ]/inner[ ]#”. ‘input[ ][ ]’ represents a two-dimensional matrix with rows and columns (if the input matrix is input[2][3], then 2 rows and 3 columns are present). The sequence ‘inner[ ]’ iterates over each row in ‘input[ ][ ]’, i.e. ‘inner[ ]’ is a specific row-sequence of ‘input[ ][ ]’ in an iteration (if input matrix is input[2][3], then inner[ ] is the 2nd row-sequence at the 2nd iteration). Line 3 is the inner loop with an iterator “inner[ ]/val#”. Variable ‘val’ iterates over each element in inner[ ] and it represents a specific value of an element in ‘inner[ ]’. For example, if the values in the 2nd row of matrix ‘input[2][3]’ are [4, 5, 6], then inner[ ] is [4, 5, 6]. Then value of ‘val’ in the 2nd iteration of the inner loop is ‘5’. Line 4 is a recursive expression with a “prev->accum” loop pointer. Line 5 is used to initialize the value of the prev->accum for the first iteration.

FIG. 5 is a flowchart 500 illustrating a variety of example accesses to loop pointer variables found in source code and compiler-generated instructions prepared in response. Compiler 130, in concert with loop context analyzer 124, evaluates source code for these accesses (505). The default is to return last->LPV as an output (540). Also illustrated are returning an array of the entire sequence (520) or a specific portion thereof (530). As just introduced, multiple nested arrays may be deployed, and the entire set of array outputs or a subset thereof may be accessed (510).

If multiple arrays are requested (510), the compiler will generate instructions to store the entire sequence of the outer iterator and one or more sequences of iterators nested within the outer iterator and return them as output (515). A subset of the output may also be specified, once the possible requisite output values have been allocated and stored (details not shown). If an array is requested, the compiler will generate instructions to store the entire sequence and return it as output (525). If a subset of the sequence is requested, which can be identified using any variation of syntax, the compiler will generate instructions to store the defined sequence and return it as output (535). If none of the above accesses apply (510-530), the compiler will generate instructions to return last->LPV as output (540).

Consider the code snippet of Example 9, which illustrates alternate syntax as well as illustrative access requests for output.

| | |
|---|---|
| 1 | sum(input[ ] :: number[ ]) = number(init : 0) |
| 2 | /input# |
| 3 | partial_sum : prev->partial_sum + input |
| 4 | |
| 5 | .console.start@ |
| 6 | debug_print |
| 7 | sum(input[ ] : [10, 20, 30]).sum_[ ] |
| 8 | sum(input[ ] : [10, 20, 30]) |
| 9 | matrix_accumulator(input[ ][ ]: mat[ ][ ]) |
| 10 | matrix_accumulator(input[ ][ ]:mat[ ][ ]).matrix_accumulator_[ |
| | ][ ] |

### Example 9. Single vs. Sequence Loop Pointer Variables

Example 9 illustrates an alternate example embodiment of function sum where the initial value of the loop pointer is predefined in line 1 (similar to Init LPV 40 in FIG. 1A). In this embodiment, the initial value being predefined informs the compiler to return the value of the loop pointer variable as output of the function after completion of all iterations in a loop computation. The initial values can also be passed as a sequence if multiple initializations are required ((init [0, 1]).

In line 5 of Example 9, ‘.console.start@’ is the starting point of execution of the program. In line 6, debug_print prints the output of the program to the console. This is included to illustrate some featured example accesses to loop pointer variable outputs.

Line 7 triggers the allocation of a loop pointer variable as a sequence which stores values of the loop pointer variable in more than one iteration. For example, line 7 returns [10, 30, 60] as the output since value of the LPV in the first iteration is 10, value of the LPV in the second iteration is 30 and the value of the LPV in the third or last iteration is 60. This is an example of step 520. An example defined sequence syntax in an embodiment may call for a sequence indexed from 0 to lag level desired. In this example, .sum_[0] is equivalent to last->partial_sum. A partial sequence, .sum_[0:1] returns the last two values, and so on (an example of 530, details not shown).

Line 8 in Example 9 allocates a loop pointer variable where the loop pointer variable stores a single value (540). Line 8 returns 60 as the output since that is the value of the loop pointer variable after the last iteration.

Accesses to the matrix_accumulator function introduced in Example 8 are included in lines 9-10. Line 9 triggers the allocation of a loop pointer variable as a singular value (540). The output returned is the value of ‘accum’ after the completion of all the iterations in the outer loop and the inner loop. Line 10 triggers the allocation of a loop pointer variable as a matrix (510). Each element of the matrix is the value of ‘accum’ after each iteration in the inner loop (the matrix stores the intermediate values of the loop pointer variable). The output returned is a matrix of the intermediate values of ‘accum’.

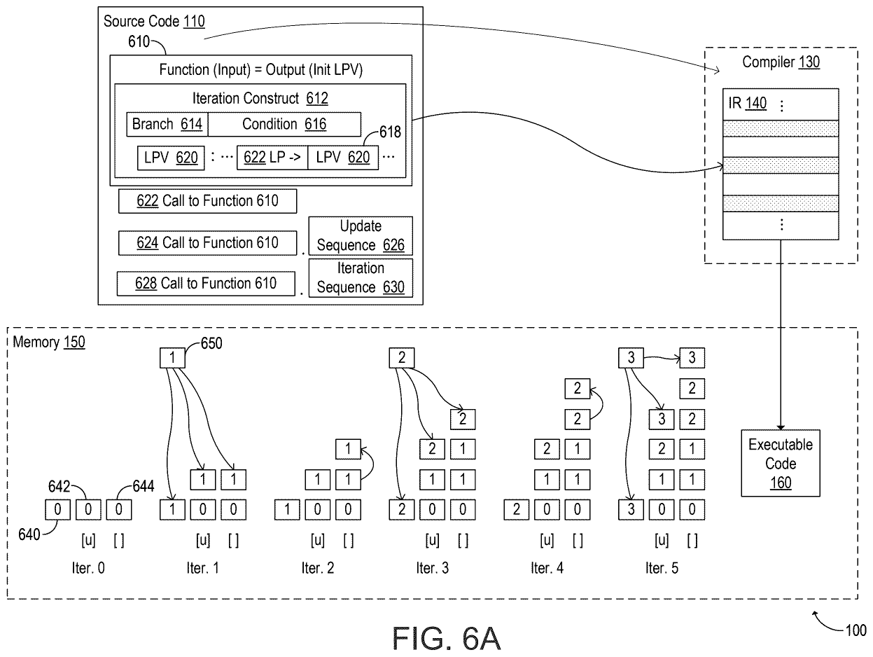

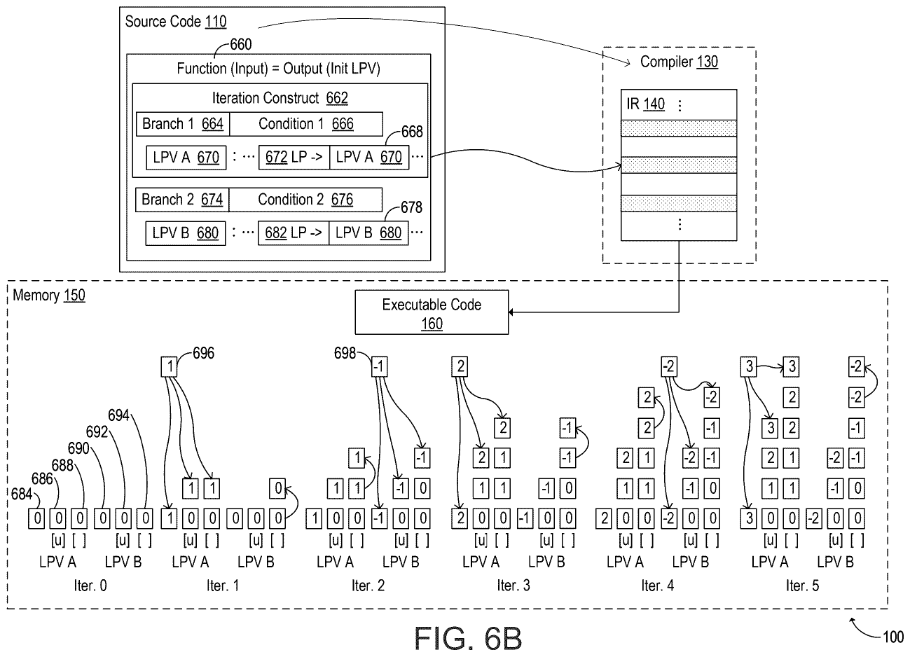

FIG. 6A illustrates loop pointers in a recursive expression enclosed within a branching construct. The computational device 100, as in FIG. 1A, has source code 110 compiled by compiler 130 into IR 140, from which executable code 160 is ultimately generated. As before, an illustrative function 610 includes an iterator construct 612. Again, an LPV 620 is computed using a recursive expression comprising a loop pointer construct 622 modifying LPV 620 in statement 618. Here, however, statement 618 is enclosed within a branching construct 614 having a condition 616. As before, the prior terms or values in the recursive statement are identified in source code by a loop pointer construct (622) modifying a reference to the loop pointer variable (620). The compiler again generates instructions to access each of one or more identified previous loop pointer variable values for use in computation of the current value, however, only when the condition (616) of the branching construct (614) is met at runtime.

An example function 610 having a loop pointer construct in a conditional branch is illustrated in Example 10, below. Function sum is declared in line 1. The iterator construct (line 2) includes an “if” condition check(line 3) enclosing the recursive expression (line 4). The input is an array of numbers and the function sum evaluates to last->partial_sum, by default. The iterator (line 2) iterates over each element in the input array. If, for an input element, the condition (line 3) is satisfied, then the recursive expression in line 4 is computed, and the LPV partial_sum is updated. The computation adds the value of partial_sum in the previous iteration (identified by loop pointer ‘prev->’ modifying LPV partial_sum) to the input. If the condition is not satisfied, the LPV partial_sum is not updated. The existing value of partial_sum is retained and supplied to the next iteration for which the input value meets the condition. The loop pointer is initialized to zero (line 5).

| | |
|---|---|
| 1 | sum(input[ ] :: number[ ]) = last->partial_sum |
| 2 | /input# |
| 3 | if(input > 0) |
| 4 | partial_sum : prev->partial_sum + input |
| 5 | init->partial_sum : 0 |
| 6 | |
| 7 | sum(input[ ] :: number[ ]) = number(init : 0) |
| 8 | /input# |
| 9 | if(input > 0) |
| 10 | partial_sum : prev->partial_sum + input |
| 11 | |
| 12 | .console.start@ |
| 13 | debug_print |
| 14 | sum(input[ ] : [1, −1, 1, −1, 1]) |
| 15 | sum(input[ ] : [1, −1, 1, −1, 1]).sum_[u] |
| 16 | sum(input[ ] : [1, −1, 1, −1, 1]).sum_[ ] |

### Example 10. Loop Pointer Construct in Conditional Branch

Lines 7-10 illustrate the same sum function in an alternate embodiment in which the initial value of the loop pointer is predefined in line 7. In this embodiment, the initial value being predefined informs the compiler to return the value of the loop pointer variable as output of the function after completion of all iterations in a loop computation.

Several example accesses to the conditional-branch iterator are illustrated in FIG. 6A as calls to function 610. A call to the function without any additional modifier will return the default output of the function. In this example, such a call 622 returns the terminal value of the loop pointer variable. In embodiments in which a loop pointer is conditionally updated, as in this example, updates to a loop pointer variable may occur less often than once per iteration. As such, two sequence access types are disclosed, referred to as an iteration sequence and an update sequence.

The iteration sequence, like in non-conditional iteration, returns a sequence of one or more values of the loop pointer variable for a corresponding sequence of iterations. However, this requires maintaining LPV values in iterations in which the LPV is not updated. Responsive to encountering an iteration access in the source code, the compiler generates instructions to allocate storage for storing the iteration sequence which includes storing the updated value of the variable during an iteration when the condition is met and storing the value of the previous iteration during an iteration when the condition is not met, and for returning the iteration sequence upon termination of the iterator. In FIG. 6A, a sequence access is included in source code 110 as a function call 624 modified (using an example “.” operator) with an update sequence construct 626.

The update sequence will comprise a sequence of loop pointer variables as updated, which may be fewer than the number of iterations. Responsive to encountering an update sequence access, the compiler generates instructions to allocate storage for storing the update sequence which includes storing the updated value of the variable to the sequence only during an iteration when the condition is met. In FIG. 6A, an iterator access is included in source code 110 as a function call 628 modified with an iterator sequence construct 630. The compiler generates the appropriate instructions responsive to the various access types encountered in the source code.

Lines 12-16 of Example 10 illustrate example embodiments of these constructs. As in earlier examples, ‘.console.start@’ is the starting point of execution of the program. In line 13, debug_print prints the output of the program to the console. Line 14 is a call to function sum with no modifier (622) indicating the terminal value of the loop pointer variable partial_sum is to be returned. Line 15 has a call to sum with an array including a construct [u] which indicates the sequence to be returned is the update sequence. Line 16 is similar, with call to sum (628), except here the construct modifying the array variable sum_is empty brackets [ ] indicating the iteration sequence is to be returned. Any number of alternate choices for syntax may be deployed in alternate embodiments. Each call has an input sequence [1, −1, 1, −1, 1].

Runtime operation of these three output options for the sum function of Example 10 is illustrated in FIG. 6A. As there are five input values, there will be five iterations. Each of the three outputs are shown side by side in each iteration period for comparison. The first column is the storage required to produce the terminal value, last->partial_sum, as a result. Only a single storage location 640 needs to be allocated, as shown. The second column shows the update sequence, [u], which has storage 642 allocated to store the update sequence. The third column shoes the iterator sequence, [ ], which has storage 644 allocated to store the iterator sequence. Prior to the iteration commencing, labeled iteration 0, each of these is initialized with the init value of zero.

In the first iteration, the input is 1, which meets the condition, so the current value (650) is computed as the input plus the loop pointer, prev->partial_sum (1+0=1). The current value is stored in each of the three columns as shown. The single value is updated in the first column. An updated value is added to the update sequence in the second column. The updated value is also added to the iteration sequence in column 3.

In iteration 2, the input is −1, which does not meet the condition. As such, the value in column 1 remains, as does the first update sequence value in column 2. Since a value for the LPV is stored for every iteration for storing in the iterator sequence, the prior value is repeated as the second iteration value of the LPV.

The input for iteration 3, 1, again meets the condition. So, the current value is computed as input plus the previous value, 1+1=2. The first column is updated, and the value is added to both sequences in the second and third columns. Iteration 4 is similar to iteration 2, with the condition not being met. The first and second columns are not updated, and an iteration sequence value, a copy of the prior iteration, is added in column 3.

In the fifth and final iteration, the input, 1, meets the condition, and the current value is computed, 1+2=3. The first column is updated, and the value is added to both sequences in the second two columns. The output for the first access type (line 14) is the terminal value, 3. The output for the update sequence (line 15) is [1 2 3]. The output for the iterator sequence (line 16) is [1 1 2 2 3].

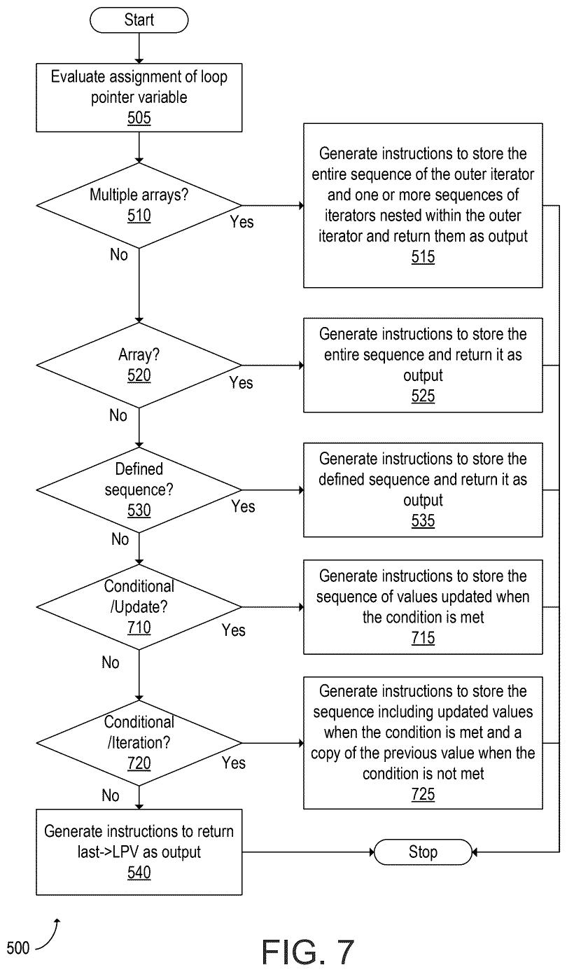

FIG. 7 shows flowchart 500 of FIG. 5 modified to support iterator access for loop pointer constructs in a conditional branch. The first three example tests (510, 520, and 530) will not be activated as they are designed in this embodiment for non-conditional LPV iteration. If the source code contains a request for an update sequence for a conditional branch LPV (710), then the compiler generates instructions to allocate storage for and to store the sequence of values as updated when the condition is met (715). If the source code contains a request for an iterator sequence for a conditional branch LPV (720), the compiler generates instructions to allocate storage for and to store the sequence including updated values when the condition is met and a copy of the previous value when the condition is not met (725). Multiple arrays of conditional/iterative sequences are also supported, details not shown. As before, if the other access types are inapplicable, the compiler generates instructions to return last->LPV as the output (540).

FIG. 6B illustrates an iterator construct having multiple branching constructs and multiple loop pointer variables. Here iteration construct 662, enclosed in function 660 for illustration, comprises two branches each enclosing one of two loop pointer variables. Branch 1 664 having condition 1 666 encloses a recursive statement 668 computing LPV A 670 responsive to at least one loop pointer, LP 672, modifying LPV A 670. Branch 2 674 having condition 2 676 encloses a recursive statement 678 computing LPV B 680 responsive to at least one loop pointer, LP 682, modifying LPV B 680.

An example of function 660 is illustrated in example 11, below. The function sum is declared in line 1. An if-else condition check (lines 3 & 6) is included in the iterator construct (line 2) with two recursive expressions (lines 4 & 7). The recursive expression in line 4 calculates the sum of positive numbers (possum, LPV A) The sum of negative numbers (neg_sum, LPV B) is obtained from the recursive expression in line 7. Either of the two recursive expressions is executed based on the condition of the branch construct. Both loop pointers are initialized to zero (lines 5 & 8).

| | |
|---|---|
| 1 | sum(input[ ]::number[ ]) = (last->pos_sum, last->neg_sum) |
| 2 | /input# |
| 3 | if(input > 0) |
| 4 | pos_sum : prev->pos_sum + input |
| 5 | init->pos_sum : 0 |
| 6 | else |
| 7 | neg_sum : prev->neg_sum + input |
| 8 | init->neg_sum : 0 |
| 9 | .console.start@ |
| 10 | debug_print |
| 11 | sum(input[ ] : [1, −1, 1, −1, 1]) |
| 12 | sum(input[ ] : [1, −1, 1, −1, 1]).pos_sum_[u], neg_sum_[u] |
| 13 | sum(input[ ] : [1, −1, 1, −1, 1]).pos_sum_[ ], neg_sum_[ ] |

### Example 11. Dual LPVs in Conditional Branches

Lines 10-13 provide the same function calls and access types used as illustration in Example 10, except that there are outputs for both of the LPVs. The update sequences are illustrated as pos_sum_[u] and neg_sum_[u] (line 12). The iterator sequences are illustrated as pos_sum_[ ] and neg_sum_[ ](line 13). The corresponding runtime operation is illustrated in FIG. 6B. The operation of LPV A is the same as in Example 10, so the results are similar here. Each iteration has two columns, one for LPV A and a second to contrast with LPV B. Each of those columns has the three access type columns (identified by a blank, [u], and [ ], as in FIG. 6A). Prior to the iteration commencing, iteration 0, there are initialization values provided for the storage locations for the loop pointers and sequences (684, 686, and 688 for LPV A, and 690, 692, and 694 for LPV B).

In the first iteration, the input is 1, which meets the condition (666 if(input>0)) for branch 1 (664). So, the current value (696) of LPV A, possum, is computed as the sum of the input and its loop pointer, prev->pos_sum (1+0=1). The current value is stored in each of the three columns for LPV A as shown. The single value is updated in the first column (684). An updated value is added to the update sequence (686) in the second column. The updated value is also added to the iteration sequence (688) in column 3. The condition (676 else) is not met for branch 2 (674), so there is no update computed for the current value of LPV B. As such there is no change to the first (690) and second columns (692), but an iteration value, a copy of the initialization value, is generated and stored in the iteration sequence (694).

In iteration 2, the input is −1, which does not meet the condition 1, but meets condition 2. So, the current value (698) of LPV B, neg_sum, is computed as the sum of the input and the loop pointer, prev->neg_sum (−1+0=−1). The current value is stored in each of the three columns for LPV A as shown. The single value is updated in the first column (690). An updated value is added to the update sequence (692) in the second column. The updated value is also added to the iteration sequence (694) in column 3. There is no update computed for the current value of LPV A. As such there is no change to the first (684) and second columns (686), but an iteration value, a copy of the prior value, is generated and stored in the iteration sequence (688).

The input for iteration 3, 1, again meets condition 1. So, the current value of LPV A computed as input plus the previous value, 1+1=2. The first column (684) is updated, and the value is added to both sequences in the second (686) and third (688) columns. As in iteration 1, only the iterator sequence (694) is updated for LPV B, and the values in 690 and 692 are retained.

Iteration 4 is similar to iteration 2, with condition 2 being met. The current value of LPV B is computed (−1+−1=−2) and all three LPV B columns are updated. The first and second columns for LPV A are not updated, but their values retained. The LPV A iteration sequence value, a copy of the prior iteration, is added in column 3.

In the fifth and final iteration, the input, 1, again meets condition 1, and the LPV A current value is computed, 1+2=3. For LPV A, the first column is updated, and the value is added to both sequences in the second two columns. For LPV B, just the iterator sequence is updated.

The output for the first access type (line 11) includes both terminal values, 3 and −2. The output for the update sequences (line 12) is A [1 2 3] and B [−1 −2]. The output for the iterator sequences (line 13) is A [1 1 2 2 3] and B [0 −1 −1 −2 −2].

The method of flowchart 400 can be adapted to support branched loop pointer variables (details not shown). For example, in FIG. 4B, the computing (435) and updating (440) steps are performed conditioned on the branch condition being met. This applies to adding to the update sequence(715) as well, as described in FIG. 7. Additional steps may be added to add a prior value to the iterator sequence (725), as applicable.

In an alternate embodiment, the compiler can automatically determine initial values and generate instructions to assign them to previous values.

| | |
|---|---|
| 1 | sum(input[ ] :: number[ ]) = last->partial_sum |
| 2 | /input# |
| 3 | partial_sum : prev->partial_sum + input |

### Example 12. Sample Auto-init Code

The sample code in Example 12 does not include an initialization value, e.g. “init->partial_sum: 0”, for prev->partial_sum. In flowchart 300 of FIG. 3, the compiler will generate an error or other message in this scenario (315). In this embodiment, instead of throwing error, the compiler performs the following steps and initializes the location allocated to prev->partial_sum.

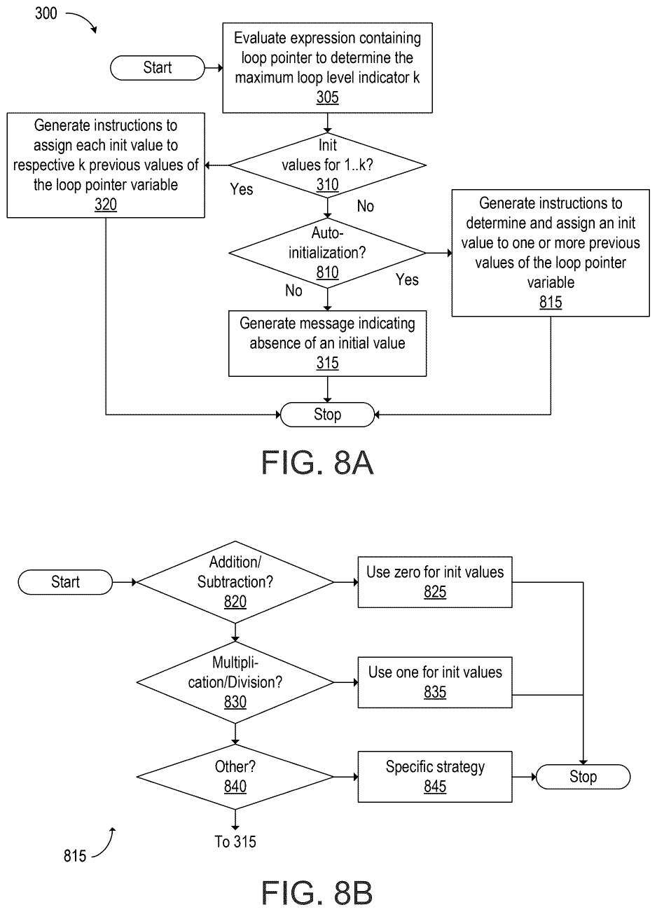

FIG. 8A is flowchart 300 of FIG. 3 modified to support auto-initialization. If one or more of the initialization values are not identified in source code (310), then, if auto-initialization is enabled (810), the compiler will generate instructions to determine and assign an initialization value to one or more previous values of the loop pointer variable (815). In this example, the compiler determines the level and type of the recursive expression in line 3 of Example 12. The expression illustrated here is simple, including a prev->partial_sum and an input with the addition operator. The compiler automatically initializes prev->partial_sum equal to zero.

FIG. 8B is an example step 815. When the compiler examines the context of the recursive expression and detects addition or subtraction (820), the compiler uses the additive identity zero for initialization (825). When multiplication or division is detected (830), the multiplicative identity of one may be used (835). In the cases involving complex expression with multiple operators or other predefined cases (840) the compiler may utilize other specific strategies to select appropriate initialization values (845). The compiler may issue a warning message to the developer. The developer has an option to over-write the value initialized by the compiler. In another embodiment, initialization can be received through the Integrated Development Environment (IDE). The IDE can prompt or suggest the developer to produce any missing initialization values.

The description herein for support in a compiler for managing the loop pointers is provided illustratively. It will be appreciated that the compiler support for managing loop pointers may be implemented in similar ways over various phases and passes of compilation, using the principles described herein.

Source code, compilable by a compiler and executable by a processor, containing recursive expressions, iterators, statements, loop pointer variables, loop pointer constructs, and other constructs such as those detailed above may be stored on a non-transitory computer-readable medium. A system may be deployed comprising one or more processors coupled to a memory, wherein one or more programs are stored in the memory and configured to be executed by the one or more processors, the one or more programs including program instructions that perform one or more of the various methods detailed above.

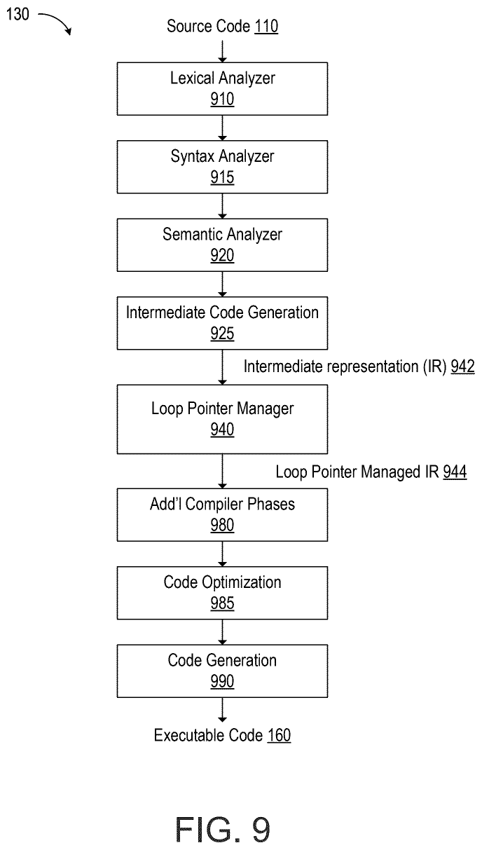

FIG. 9 is an example compiler 130 illustrating Loop Pointer Manager 940 operating on an intermediate representation. Lexical analyzer 910 performs lexical analysis, also known as scanning, where source code is 110 is converted into a sequence of lexical units or tokens. Tokens are the smallest meaningful units of a programming language, such as keywords, identifiers, operators, and literals.

Syntax analyzer 915 performs syntax analysis, also known as parsing, where the compiler checks whether the sequence of tokens generated by the lexical analyzer 910 conforms to the rules defined by the programming language's grammar. This analysis typically involves constructing a parse tree or syntax tree (e.g. an AST) that represents the hierarchical structure of the source code.

Semantic analyzer 920 performs semantic analysis where the compiler examines the meaning of the statements and expressions in the source code beyond their syntactic structure. During semantic analysis, the compiler checks for semantic correctness, such as type compatibility, undeclared variables, and adherence to language-specific constraints. It also performs various optimizations and transformations based on the semantic properties of the code.

Intermediate code generation module 925 generates an intermediate representation (IR) 942 of the source code after semantic analysis and optimization, but before the final machine code. Often during intermediate code generation, the compiler translates high-level source code into an IR that is closer to the target machine language but still independent of the target machine architecture. This intermediate code is typically in the form of low-level instructions or an intermediate language. The main purpose of intermediate code generation is to provide a platform-independent representation of the source code that facilitates further optimization and simplifies the task of generating machine code for different target architectures. A variety of compiling processes may be applied to code in intermediate form. IR 942 may include one or more of any of a variety of forms, including but not necessarily a control flow graph, static single assignment, three-address code, intermediate representation language, an abstract syntax tree, and the like.

Code optimization module 985 is where the intermediate representation is improved to enhance its efficiency in terms of execution time, memory usage, or other performance metrics. During code optimization, the compiler applies various techniques and transformations to the intermediate code to eliminate redundant operations, minimize resource usage, and improve the overall quality of the generated code. Optimization techniques may include constant folding, dead code elimination, loop optimization, and many others. The primary goal of code optimization is to produce optimized code that executes more efficiently on the target platform, resulting in improved performance and reduced resource consumption. Other embodiments may employ different or additional compiler phases processing the IR for other purposes.

Code generation module 990 is where the optimized intermediate representation of the source code is translated into executable machine code specific to the target platform. During code generation, the compiler maps the instructions and constructs of the intermediate code to the corresponding machine instructions of and taking advantage of the specific features and optimizations offered by the target architecture. This involves generating assembly code or machine code that directly controls the behavior of the target hardware. Note that code generation may be carried out in multiple phases. For example, a low-level language such as c/llvm may be an intermediate target of code generation 990. An intermediate level compilation can be further processed into executable code 160 for one or more target processors and/or architectures.

In this embodiment, the Loop Pointer Manager 940 operates on IR 942 to produce Loop Pointer Managed IR 944, which is used in additional compiler phases 980 and leading to code optimization and code generation. An example phase 940 may implement functions of LP Keyword Checker 122, Loop Level Indicator Analyzer 123, Loop Context Analyzer 124, and code injection 125, as detailed above. The code that is generated can be compiled along with other code in the IR. In alternative embodiments, code can be injected into the executable during code generation 990 as well, or a combination of both.

The description for compiler 130 support of LPM is provided illustratively. Any number of other embodiments may be deployed where LPM instructions are generated in any compiler phase or code format. It will be appreciated that it may be implemented in alternate ways over any of various phases and passes of compilation, using the principles described herein.

A compiler, examples of which are described above, is a program that translates source code instructions for performing computational functions into machine code that can be executed by a computer, alternatively referred to as binaries, executable code, execution code, application code, etc. Some languages are not compiled but are rather interpreted. Interpretation differs from compilation in that the interpreter executes programs directly from source code without producing a standalone executable. The prior discussion focuses on compilers, but those of skill in the art will recognize compiling source code to an executable that is run on a computer can be substituted with a process of interpreting the source code while running on an interpreter.

Source code is typically written in a high-level programming language, which is designed to be easy to read and understand by developers. Intermediate representations and machine code are written in more compact and efficient lower-level languages. An intermediate representation generated from one form of source code can itself be a form of source code. The methods detailed herein can be applied to original source code or various levels of source code derived therefrom. A keyword from one form of source code may be transformed to or represented by a different keyword, numerical value, or token when processed into another form of source code or intermediate representation. A reference to a particular keyword in the methods, systems and devices described herein applies equally to any transformation or alternate representation.

Program execution generally takes place on computer hardware in a runtime environment. The computer hardware comprises processors, memory, and storage. The runtime environment is a set of software tools and resources that runs on the computer hardware to execute a program. The runtime environment includes the operating system, libraries, and other components that are necessary for the program to run. Computer hardware and runtime environments are well known to those of skill in the art.

FIG. 10 illustrates an example embodiment of distributed IDE 1000 including components of a computational device, or user terminal, 100. Here user terminal 100 is connected via network 1040 with other user terminals 100a-n and a project server 1050. However, it should be noted that an IDE operating environment, a computational device 100, and the aspects disclosed herein are not constrained to any particular configuration of devices.

User terminals 100 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, an Internet-of-Things (IOT) device, a distributed computing system, multiprocessor systems, or combination thereof. A user terminal may be configured utilizing a cloud service. The operating environment of IDE 1000 may be configured in a network environment, a distributed environment, a multi-processor environment, or a stand-alone computing device having access to remote or local storage devices.

User terminals 100 may include one or more processors 1010, a communication interface 1012, one or more storage devices 1016, one or more input/output devices 1018, and a memory 150. A processor 1010 may be any commercially available or customized processor and may include multi-processor architectures. The communication interface 1012 facilitates wired or wireless communications between the computing devices such as user terminals 100, project server 1050, and other devices. The components of a user terminal 100 are communicatively coupled via one or more buses 1014.

A storage device 1016 may be a computer-readable medium that does not contain propagating signals, such as modulated data signals transmitted through a carrier wave. Examples of a storage device 1016 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1016 in the computing devices 100. The input/output devices 1018 may include a keyboard, mouse, pen, voice input device, touch input device, display, speakers, printers, etc., and any combination thereof.

A memory 150 may be any non-transitory computer-readable storage media that may store executable procedures, applications, and data. Various of these components and data are detailed above with respect to FIGS. 1A-B and 6A-B. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. Amemory 150 may also include one or more external storage devices or remotely located storage devices.

The memory 150 may contain instructions, components, and data. A component is a software program that performs a specific function and is otherwise known as a module, program, and/or application. The memory 150 may include an operating system 1030, one or more source code files 110, a compiler 130, executable code 160, and other applications and data 1036. Compiler 130 may include a lexical analyzer 910, a syntax analyzer 915, a semantic analyzer 920, an intermediate code generation module 925, a code optimization module 985, a code generation module 990, a Loop Pointer Manager (LPM) 120, an abstract syntax tree 1046, and an intermediate representation 140, and a control flow graph 1048.

User terminal 100 may utilize an Integrated Development Environment (IDE) (details not shown) that allows a user (e.g., developer, programmer, designer, coder, etc.) to design, code, compile, test, run, edit, debug, or build a program, set of programs, web sites, web applications, and web services in a computer system. Software programs can include source code files 110, created in one or more source code languages (e.g., Visual Basic, Visual J#, C++. C#, J#, Java Script, APL, COBOL, Pascal, Eiffel, Haskell, ML, Oberon, Perl, Python, Scheme, Smalltalk and the like, as well as proprietary or custom-designed programming languages). The IDE may provide a native code development environment or may provide a managed code development that runs on a virtual machine or may provide a combination thereof. The IDE may provide a managed code development environment using a framework such as Java SE, NET, Node.js, Python Frameworks such as Django, Flask, etc., Ruby on Rails, PUP Frameworks such as Laravel, Symfony, etc., React, and others. It should be noted that this operating environment embodiment is not constrained to providing the source code development services through an IDE and that other tools may be utilized instead, such as a stand-alone source code editor and the like.

Project server 1050 may be any type of electronic device, including without limitation those detailed for user terminals 100. A project server may be configured utilizing a cloud service.

The user terminals 100 and project server 1050 may be communicatively coupled via network 1040. The network 1040 may be configured as an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Network (MAN), the Internet, a portion of the Public Switched Telephone Network (PSTN), Plain Old Telephone Service (POTS) network, a wireless network, a WiFi® network, or any other type of network or combination of networks.

The network 1040 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative and not limiting. Therefore, the spirit and scope of the appended claims should not be limited to the foregoing description. In U.S. applications, only those claims specifically reciting “means for” or “step for” should be construed in the manner required under 35 U.S.C. § 112(f).

What is claimed is:

1. A method of compiling source code comprising:
encountering in the source code an iterator construct comprising a branching construct having a condition, the branching construct comprising a statement defining computation of a current value of a variable, the statement including one or more references to the variable modified by a pointer construct, each pointer construct identifying one of the previous values of the variable for use in computation of the current value of the variable; and
generating instructions to access the one or more identified previous values for use in computation of the current value of the variable when the condition of the branching construct is met at runtime.

2. The method of claim 1, further comprising:
encountering a second statement assigning a value to the variable modified by a pointer construct in the source code; and
preventing compilation of the second statement.

3. The method of claim 1, further comprising determining whether a set of initial values is defined within the source code, the set of initial values including an initial value for each of the one or more identified previous values of the variable and the zero or more previous values between the one or more identified previous values and the current value of the variable.

4. The method of claim 3, further comprising, responsive to determining the set of initial values are defined within the source code, generating instructions to assign each initial value to a previous value of the variable.

5. The method of claim 3, further comprising, responsive to determining the set of initial values are not defined within the source code, generating a compiler message to indicate the absence of an initial value.

6. The method of claim 1, wherein the source code further comprises an access to the output of the iterator construct signifying the terminal iteration value is to be returned.

7. The method of claim 1, wherein the source code further comprises an access to the output of the iterator construct signifying a sequence of one or more previous values of the variable are to be returned.

8. The method of claim 7, further comprising generating instructions to store the sequence of one or more previous values of the variable, wherein a previous value of the variable is added to the sequence when the condition of the branching construct is met at runtime.

9. The method of claim 1, further comprising generating instructions to retain the value of the variable from the prior iteration when the condition of the branching construct is not met at runtime.

10. The method of claim 1, wherein the source code further comprises an access to the output of the iterator construct signifying a sequence of variable values are to be returned, each variable value in the sequence corresponding to the variable value during one of a sequence of iterations.

11. The method of claim 7, further comprising generating instructions to store the sequence of variable values, wherein a variable value is added to the sequence each iteration at runtime.

12. The method of claim 1, wherein the branching construct includes a second condition, the branching construct comprising a second statement defining computation of a current value of a second variable, the statement including one or more references to the second variable modified by a pointer construct, each pointer construct identifying one of the previous values of the second variable for use in computation of the current value of the second variable; and
generating instructions to access each of the one or more identified second variable values for use in computation of the current value of the second variable when the second condition of the branching construct is met at runtime.

13. The method of claim 1, wherein the source code further comprises a second iterator construct in which the first-mentioned iterator construct is nested.

14. The method of claim 1, wherein the iterator construct is within a function construct including the iterator construct.

15. The method of claim 1, wherein the iterator construct is within the main body of a program.

16. The method of claim 1, further comprising generating instructions that compile to runtime instructions that, responsive to the compiled iteration instructions receiving an input for which no iteration is performed, returning an initial value as the output of the compiled iteration instructions.

17. The method of claim 1, further comprising generating instructions that compile to runtime instructions that, responsive to the condition of the branching construct not being met at runtime, returning an initial value as the output of the compiled iteration instructions.

18. The method of claim 1, further comprising:
encountering in the source code an enclosing construct having a reference to the variable modified by a pointer construct; and
responsive to encountering the pointer construct, generating instructions to return the terminal iteration value of the variable to the enclosing construct.

19. A non-transitory computer-readable medium having stored thereon a source code compilable by a compiler and executable by a processor, the source code comprising:
a code segment including an iterator construct comprising a branching construct having a condition, the branching construct comprising a statement defining computation of a current value of a variable, the statement including one or more references to the variable modified by a pointer construct, each pointer construct identifying one of the previous values of the variable for use in computation of the current value of the variable when the condition of the branching construct is met at runtime.

20. The media of claim 19, wherein the source code further comprises an access to the output of the iterator construct signifying a sequence of one or more previous values of the variable are to be returned.

21. The media of claim 19, wherein the source code further comprises an initial value corresponding to each of the one or more identified previous values of the variable and the zero or more previous values of the variable between the one or more identified variable values and the current value of the variable.

22. The media of claim 19, wherein the source code further comprises an access to the output of the iterator construct signifying the terminal iteration value is to be returned.

23. The media of claim 20, wherein the access indicates to the compiler to generate instructions to store the sequence of one or more previous values of the variable and add a previous value of the variable to the sequence when the condition of the branching construct is met at runtime.

24. The media of claim 19, wherein the source code further comprises an access to the output of the iterator construct signifying a sequence of variable values in each of one or more iterations are to be returned.
